(19) United States
(12) Patent Application Publication
(10) Pub. No.: US 2013/0284337 A1
(43) Pub. Date: Oct. 31, 2013

(54) ACCORDION SPIRAL OVERLAY FOR A PNEUMATIC TIRE

(71) Applicant: Bernard Jean Francois Croissant, Bastogne (BE)

(72) Inventor: Bernard Jean Francois Croissant, Bastogne (BE)

(21) Appl. No.: 13/456,656

(22) Filed: Apr. 26, 2012

(51) Int. Cl. B60C 9/18

(52) U.S. Cl. CPC B60C 9/18
USPC 152/527

(57) ABSTRACT

A pneumatic tire includes a carcass and a belt reinforcement structure. The carcass has one ply of parallel cords extending proximately to bead portions. The belt reinforcement structure is disposed radially outside of the carcass. The belt reinforcement structure includes an overlay ply. The overlay ply includes a strip of parallel cords wound spirally and circumferentially from a first axially outer side of the overlay ply to a second axially outer side of the overlay ply. The distance between corresponding parts of adjacent strip windings defines a winding pitch. The winding pitch of the strip changes in an axially inward direction of the pneumatic tire towards the equatorial plane of the pneumatic tire such that the winding pitch in a central region of the belt reinforcement structure is increased relative to respective first and second axially outer sides of the overlay ply on each side of the equatorial plane of the pneumatic tire.

The present invention relates to a pneumatic tire and, more specifically, to an overlay ply for a pneumatic tire.

### BACKGROUND OF THE INVENTION

Conventionally, a radial tire may be provided with a belt reinforcement comprising breaker plies and a band ply (or overlay), wherein the band cords may be generally laid in parallel with the circumferential direction of the tire and the breaker cords may be inclined with respect to the circumferential direction. Edge plies may be effective for increasing the hooping force at the breaker edges, and accordingly effective for preventing ply edge looseness and separation.

Such a band ply may be formed by winding a ply material having the same width as its finishing width, around the carcass, and the ends of the ply may be overlapped at a predetermined length. Accordingly, thickness and rigidity may be increased at the overlap, and RRO (Radial Runout) may be increased, and further, the tire uniformity may be disturbed.

A jointless band ply may be used by forming an edge ply at each edge of a breaker and winding a strip separately at each breaker edge. Since the number of the windings or turns in each band ply may be small and the both ends of the strip may be free, the wound strip may loosen and shift during a tire vulcanizing process by the increased cord tension, and accordingly the band ply may have an uneven thickness distribution to increase RRO and disturb tire uniformity.

One conventional jointless band ply may comprise a strip wound spirally at regular pitches from one edge to the other edge of a breaker, while slightly overlapping the adjacent edges thereof. Accordingly, the hoop effect may not be increased at the breaker edge regions where a strong hooping force may be required.

Another conventional band may have a double layered structure at the edge of a breaker similar to a band ply wherein a strip, including reinforcing cords of 1 to 20 in number may be wound, while traversing a breaker. However, the traversing direction may be changed at least twice wind the strip around a previously wound portion thereof. Therefore, the band ply may not obtain a dimensional accuracy and a positional accuracy, as well reducing productivity.

Another conventional band ply may be a strip wound around a breaker wherein the strip may be overlapped. In a central region, the overlap may be 50% of the strip width and the overlap may be increased to 75% in side regions. Accordingly, the band ply may have a double layered structure even in the central region, which may result in an increase in the hooping force in the central region as well as a decrease in cornering stiffness. The tire weight may also increase.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same reference to the equatorial plane of the tire as the parallel reinforcing cords in carcass plies.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” (for cords) means weight per unit length, i.e., denier, dtex, etc.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies of which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means a space (open or rubber filled) between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); and 5) a narrow strip of material with or without twist.

### SUMMARY OF THE INVENTION

A first example pneumatic tire in accordance with the present invention includes a carcass extending between bead portions through sidewall portions and a tread portion and a belt reinforcement structure. The carcass has at least one ply of parallel cords extending proximately to bead cores of the bead portions. The belt reinforcement structure is disposed radially outside of the carcass and radially inside of the tread portion. The belt reinforcement structure includes an overlay ply. The overlay ply includes a strip of parallel cords wound spirally and circumferentially from a first axially outer side of the overlay ply to a second axially outer side of the overlay ply. The distance between corresponding parts of adjacent strip windings defines a winding pitch. The winding pitch of the strip changes in an axially inward direction of the pneumatic tire towards the equatorial plane of the pneumatic tire such that the winding pitch in a central region of the belt reinforcement structure is increased relative to respective first and second axially outer sides of the overlay ply on each side of the equatorial plane of the pneumatic tire. The winding pitch of the strip at both axially outer sides of the overlay ply is in a range from 55% to 233% a width of the strip. A width of the central region is in a range from ⅓ to ⅞ a width of the belt reinforcement structure. Spaces of 4 mm to 20 mm are formed in the central region between axially adjacent edges of the strip of the overlay ply. Spaces of 27% to 133% of the width of the strip are formed in the central region between the axially adjacent edges of the strip of the overlay ply.

According to another aspect of the first example pneumatic tire, the winding pitch at both axially outer sides is in a range from 55% to 85% of the width of the strip.

According to still another aspect of the first example pneumatic tire, the winding pitch at both axially outer sides is in a range from 60% to 75% or 65% to 70% of the width of the strip.

According to yet another aspect of the first example pneumatic tire, the winding pitch at both axially outer sides being in a range from 100% to 233% of the width of the strip.

According to still another aspect of the first example pneumatic tire, the width of the central region is 33% to 83% a width of the belt reinforcement structure.\

According to yet another aspect of the first example pneumatic tire, spaces from 4 mm to 12 mm are formed in the central region between axially adjacent edges of the strip of the overlay ply.

According to still another aspect of the first example pneumatic tire, spaces of 27% to 80% of the strip are formed in the central region between the axially adjacent edges of the strip of the overlay ply.

According to yet another aspect of the first example pneumatic tire, the belt reinforcement structure comprises at least one breaker layer. The at least one breaker layer is disposed radially outside the carcass. The at least one breaker layer comprising two plies of cords inclined with respect to the equatorial plane of the pneumatic tire such that cords in one ply cross cords in the other ply.

According to still another aspect of the first example pneumatic tire, the overlay ply is disposed radially outside of the breaker layer and the strip of parallel cords is wound spirally and circumferentially around the breaker layer from about one axial edge of the breaker layer to about the other axial edge of the breaker layer.

According to yet another aspect of the first example pneumatic tire, the overlay ply is disposed radially outside of the breaker layer and the strip of parallel cords is wound spirally and circumferentially around the breaker layer from overhanging one axial edge of the breaker layer to overhanging the other axial edge of the breaker layer such that each axial edge of overlay ply is aligned proximate to a respective axial edge of the breaker layer.

According to still another aspect of the first example pneumatic tire, the width of the strip is in a range from 9 mm to 27 mm.

According to yet another aspect of the first example pneumatic tire, the winding pitch of the strip changes continuously from in an axially inward direction towards the equatorial plane of the pneumatic tire such that the winding pitch in a central region of the belt reinforcement structure is increased continuously compared to the respective first and second axially outer side to the equatorial plane of the pneumatic tire on each side of the equatorial plane.

According to still another aspect of the first example pneumatic tire, the winding pitch forms an accordion structure.

According to yet another aspect of the first example pneumatic tire, the winding pitch of the strip changes in steps, from in an axially inward direction towards the equatorial plane of the pneumatic tire such that the winding pitch in a central region of the belt reinforcement structure is increased in steps compared to the respective first and second axially outer side to the equatorial plane of the pneumatic tire on each side of the equatorial plane.

According to still another aspect of the first example pneumatic tire, the winding pitch forms an accordion structure.

According to yet another aspect of the first example pneumatic tire, the thickness of the strip is in the range from 0.5 mm to 1.1 mm.

According to still another aspect of the first example pneumatic tire, the winding pitch in the central region at the equatorial plane of the pneumatic tire is about two times the winding pitch at the first and second axially outer side.

According to yet another aspect of the first example pneumatic tire, the spirally and circumferentially wound strip is a continuous spirally and circumferentially wound strip.

A second example pneumatic tire in accordance with the present invention includes a carcass extending between bead portions through sidewall portions and a tread portion and a belt reinforcement structure. The carcass has at least one ply of parallel cords extending proximate to bead cores of the bead portions. The belt reinforcement structure is disposed radially outside of the carcass and radially inside of the tread portion. The belt reinforcement structure includes an overlay ply and at least one breaker layer. The at least one breaker layer is disposed radially outside the carcass and radially inside the overlay ply. The at least one breaker layer includes two plies of cords inclined with respect to the equatorial plane of the pneumatic tire such that cords in one ply cross cords in the other ply. The overlay ply includes a strip of parallel cords wound spirally and circumferentially from a first axially outer side of the overlay ply to a second axially outer side of the overlay ply. The distance between corresponding parts of adjacent strip windings defines a winding pitch. The winding pitch of the strip changes in an axially inward direction of the pneumatic tire towards the equatorial plane of the pneumatic tire such that the winding pitch in a central region of the belt reinforcement structure is increased compared to the respective first and second axially outer sides of the overlay ply on each side of the equatorial plane. The winding pitch at both axially outer sides being in a range of from 55% to 85% of a width of the strip. The width of the central region being in a range of from ⅓ to ⅚ a width of the belt reinforcement structure. Spaces of 4 mm to 12 mm are formed in the central region between the axially adjacent edges of the strip of the overlay ply. Spaces of 27% to 80% of the width of the strip are formed in the central region between the axially adjacent edges of the strip of the overlay ply.

A third example pneumatic tire in accordance with the present invention includes a carcass extending between bead portions through sidewall portions and a tread portion and a belt reinforcement structure. The carcass has at least one ply of parallel cords extending proximate to bead cores of the bead portions. The belt reinforcement structure is disposed radially outside of the carcass and radially inside of the tread portion. The belt reinforcement structure includes an overlay ply and at least one breaker layer. The at least one breaker layer is disposed radially outside the carcass and radially inside the overlay ply. The at least one breaker layer includes two plies of cords inclined with respect to the equatorial plane of the pneumatic tire such that cords in one ply cross cords in the other ply. The overlay ply includes a strip of parallel cords wound spirally and circumferentially from a first axially outer side of the overlay ply to a second axially outer side of the overlay ply. The distance between corresponding parts of adjacent strip defines a winding pitch. The winding pitch of the strip changes in an axially inward direction of the pneumatic tire towards the equatorial plane of the pneumatic tire such that the winding pitch in a central region of the belt reinforcement structure is increased compared to the respective first and second axially outer sides of the overlay ply on each side of the equatorial plane. The winding pitch at both axially outer sides being in a range from 100% to 233% of a width of the strip such that the strip at both axially outer sides does not overlap. The width of the central region is in a range of from ⅓ to ⅚ a width of the belt reinforcement structure. Spaces of 4 mm to 12 mm are formed in the central region between the axially adjacent edges of the strip of the overlay ply. Spaces of 27% to 80% of the width of the strip are formed in the central region between the axially adjacent edges of the strip of the overlay ply.

### BRIEF DESCRIPTION OF THE DRAWINGS

Example embodiments of the present invention will now be described in detail with reference to the accompanying drawings, in which:

FIG. 1 is a schematic sectional view showing an example of the present invention;

FIG. 2 is a schematic sectional view an overlay ply in accordance with the present invention; and

FIG. 3 is a schematic sectional view of the example overlay ply of FIG. 2.

### DETAILED DESCRIPTION OF AN EXAMPLE OF THE PRESENT INVENTION

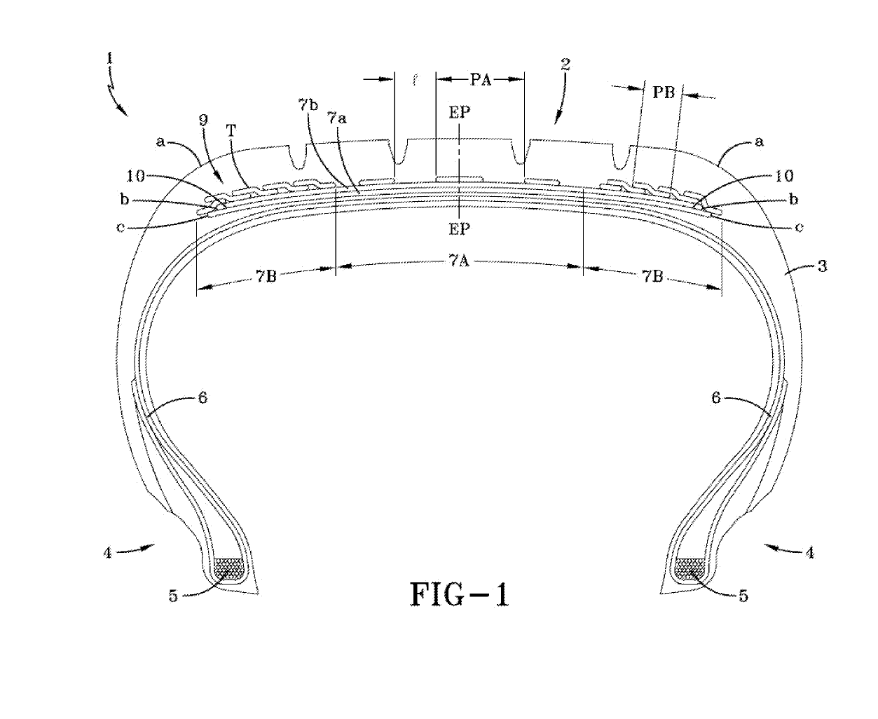

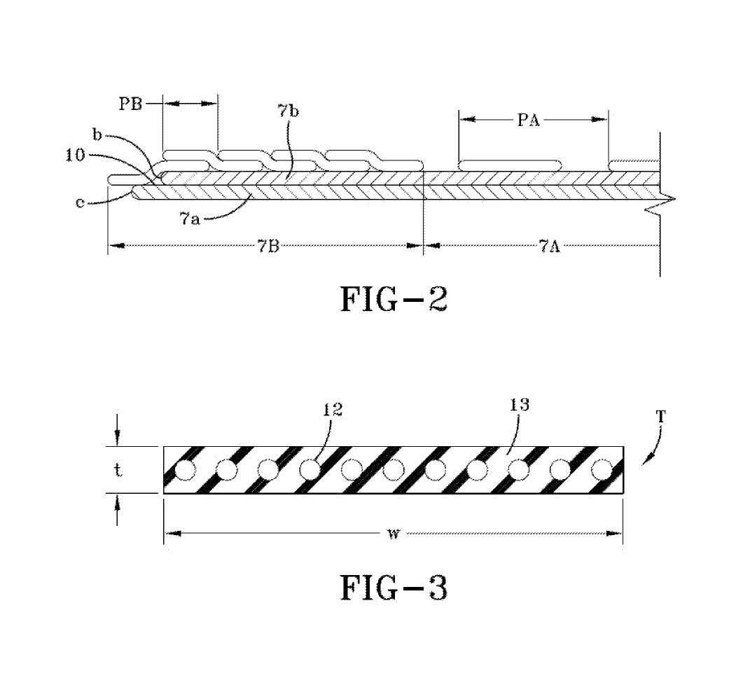

In FIGS. 1 and 2, a pneumatic tire 1 may include a pair of bead cores 5 disposed one in each bead portion 4 of the pneumatic tire, a carcass 6 extending between the bead portions through a tread portion 2 and sidewall portions 3 of the pneumatic tire and optionally turned up around the bead cores 5 from the inside to the outside of the pneumatic tire, and a belt reinforcement disposed between the carcass and the tread portion. The tread portion 2 may be disposed radially outside the carcass 6. The belt reinforcement may include a breaker layer 7a, 7b disposed radially outside the carcass 6 and an overlay ply 9, or band ply, disposed radially outside of the breaker.

The carcass 6 may include at least one ply of cords arranged radially at 70 to 90 degrees with respect to the equatorial plane EP of the pneumatic tire 1. These cords may be inorganic fiber cords, such as steel, glass, carbon, etc., or organic fiber cords, such as nylon, polyester, rayon, aromatic polyamide, aramid, etc. The breaker 7 may include two plies 7a, 7b of parallel cords. The radially inner ply 7a may have an axial width close to the tread width between the edges a of the tread portion 2. The radially outer ply 7b may have a narrower width than the inner ply 7a. The inner ply 7a may include portions 10 projecting from the edges b of the outer ply 7b to the edges c of the inner ply 7a.

The breaker plies 7a, 7b may have high modulus cords, such as steel cords, aromatic polyamide cords, etc. The breaker cords may be arranged parallel each other and inclined at small angles (e.g., 18° to 32)° with respect to the equatorial plane EP to cross the cords of the other breaker 7b, 7a such that the pneumatic tire 1 may not have directional characteristics and may have an improved reinforcing and hooping effect by the breaker plies 7a, 7b. The breaker plies 7a, 7b may be formed by winding a ply material with the same width as the finished ply width.

The overlay ply 9 may be formed by winding a narrow band strip T around the breaker ply 7b spirally and continuously from one edge to the other edge thereof, in FIG. 2 overhanging the left edge c overhanging the right edge c of the inner breaker ply 7a. As shown in FIG. 3, the band strip T may have reinforcing cords 12 laid in parallel to each other in the lengthwise direction of the band strip and a topping rubber 13 in which the reinforcing cords may be embedded. The cords may alternatively be arranged in the widthwise direction of the strip T (not shown).

The spiral wound pitch P of the band strip T may continuously increase at a first rate as the band strip T travels axially inward within a central region 7A of the breaker plies 7a, 7b and may be constant (or slightly increasing inward) in side regions 7B of the breaker plies. The central region 7A may be centered on the equatorial plane EP and the width thereof may be, for example, 33% to 83% or 33% to 66% or 33% to 88% times the axial width between the edges c of the inner breaker ply 7a. In each of the side regions 7B, the spiral pitches PA may be set, for example, at substantially 50% or 55% to 233% or 60% to 75% or 65% to 70% or 67% or 100% to 233% or 100% 105% or 55% to 85% the width w of the band strip T. In the central region 7A, the spiral pitch PA as the band strip T travels radially inward within the central region 7A of the breaker plies 7a, 7b may be such that the spaces L between the axially adjacent parts of the wound band strip may be continuously increasing. An example band strip T may have a width w of 9 mm to 27 mm or 10 mm or 15 mm or 20 mm or 25 mm with a side region pitch PB of 7.5 mm and a central region pitch PA continuously increasing to as much as 100 mm at the equatorial plane EP, where the pitch PA may begin to continuously decrease as the band strip T travels to the other side region thereby forming an accordion-like structure. Spaces of 4 mm to 20 or 4 mm to 12 mm may be formed in the central region 7A between axially adjacent edges of the strip T of the overlay ply 9. Spaces of 27% to 133% or 27% to 80% of the width w of the strip T may be formed in the central region 7A between the axially adjacent edges of the strip T of the overlay ply 9.

The band strip T may thus cover the entire width of the side regions 7B of the breakers 7a, 7b. Accordingly, at the edges c of the breakers 7a, 7b, the band strip T may be wound completely along those edges c (e.g., the first turn and last turn of the band strip may be made circumferentially along the respective edges). In the winding process, at such first and last ends, the band strip T may protrude from the edges c by a half strip width w and the protruding portions may remain or be cut off.

The number of the reinforcing cords in the band strip T may be in the range of 10 to 25 such that the band strip has a suitable width w for winding work allowing a smooth change in the pitch PA of the central region 7A. If the number is less than 10, the width w of the band strip T may be too small, and the winding work efficiency may be poor and the dimensional accuracy of the band strip may be lost. If the number is more than 25, the width w of the band strip T may be too large, and the strip may be creased in the transitional central region 7A, which also may result in a poor winding efficiency.

The width w of the band strip T may be in the range of 10 mm to 30 mm, or 12 mm to 25 mm. The thickness t of the band strip T may be in the range of 0.5 mm to 1.1 mm. In order to reduce the difference in rigidity between the stiff breakers 7a, 7b and the rubber of the tread portion 2, example nylon or polyester fiber cords 12 may have a tensile strength of not more than 100 kgf/mm² and be used for reinforcing the band strip T and overlay ply 9.

Particularly, nylon cords may have a heat shrinking characteristic for increasing the hooping force of the band strip T to the breaker 7a, 7b through the vulcanizing process. For example, 6,6-nylon cords with cord thickness and elongation specified in 7.7 Elongation Percentage in Constant Load in JIS-L1017, Testing Methods for Chemical Fiber Tire Cords and an elastic modulus of 1000d/2 to 1500d/2, 8% to 10%, and 4×10⁴ to 10×10⁴ kgf/sq·cm, respectively, may be used. Further, for the topping rubber 13 of the band strip T, various rubber compounds may be used, but a compound containing 30 to 95 parts by weight of natural rubber (NR) and 5 to 70 parts by weight of styrene-butadiene rubber (SBR) may demonstrate strength and durability against repeated deformation and a well-controlled temperature rise due to the hysteresis loss.

Such an overlay ply 9 may thus reduce tire cost by decreasing turns of band strip T (e.g., as many as 3). The increasing pitch PA to the equatorial plane EP may thus form an accordion structure in the center region 7A of the breaker plies 7a, 7b. mm).

As explained above, the overlay ply may be formed by winding a strip spirally and continuously from one edge to the other edge of the breaker. Therefore, the thickness variation of the band in the circumferential direction of the tire is restricted only at the starting end and the stopping end of the wound strip, and the uniformity of the tire may be improved and RRO reduced. Further, as the winding pitch may be set at a half of the strip width in the side regions, the overlay ply may have a double-layered structure, but in the central region, the winding pitch may be greater than in the side regions. Therefore the hoop effect of the overlay ply may be varied axially to be larger in the side regions than in the central region.

As stated above, an overlay ply structure 9 in accordance with the present invention produces excellent cost, weight, and performance characteristics in a pneumatic tire 1. This structure 9 thus enhances the performance of the tire pneumatic 1, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the overlay structure, typically made up of many parallel cords of materials embedded in, and bonded to, a matrix of low modulus polymeric material, usually natural or synthetic rubber. Id. at 207 through 208.

The cords may be disposed as a double layer. Id. at 208. Tire manufacturers throughout the industry cannot agree or predict the effect of different twists of cords of the overlay structure on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, the overlay structure cord characteristics affect the other components of a pneumatic tire (i.e., overlay structure affects carcass, apex, belt ply, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (e.g., winding pitch) of the overlay of a pneumatic tire is modified with the intent to improve one functional property of the pneumatic tire, any number of other functional properties may be unacceptably degraded. Furthermore, the interaction between the overlay structure and the carcass, apex, belt ply, and tread may also unacceptably affect the functional properties of the pneumatic tire. A modification of the overlay structure may not even improve that one functional property because of these complex interrelationships.

Thus, as stated above, the complexity of the interrelationships of the multiple components makes the actual result of modification of an overlay structure 9 in accordance with the present invention, impossible to predict or foresee from the infinite possible results. Only through extensive experimentation has the accordion overlay structure 9 of the present invention been revealed as an excellent, albeit unexpected and unpredictable, option for a pneumatic tire.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A pneumatic tire comprising:
a carcass extending between bead portions through sidewall portions and a tread portion, the carcass having at least one ply of parallel cords extending proximately to bead cores of the bead portions; and
a belt reinforcement structure disposed radially outside of the carcass and radially inside of the tread portion, the belt reinforcement structure comprising an overlay ply,
the overlay ply includes a strip of parallel cords wound spirally and circumferentially from a first axially outer side of the overlay ply to a second axially outer side of the overlay ply, the distance between corresponding parts of adjacent strip windings defining a winding pitch;
the winding pitch of the strip changing in an axially inward direction of the pneumatic tire towards the equatorial plane of the pneumatic tire such that the winding pitch in a central region of the belt reinforcement structure is increased relative to respective first and second axially outer sides of the overlay ply on each side of the equatorial plane of the pneumatic tire,
the winding pitch of the strip at both axially outer sides of the overlay ply being in a range from 55% to 233% a width of the strip, a width of the central region being in a range from ⅓ to ⅞ a width of the belt reinforcement structure,
spaces of 4 mm to 20 mm being formed in the central region between axially adjacent edges of the strip of the overlay ply,
spaces of 27% to 133% of the width of the strip being formed in the central region between the axially adjacent edges of the strip of the overlay ply.

2. The pneumatic tire as set forth in claim 1 wherein the winding pitch at both axially outer sides is in a range from 55% to 85% of the width of the strip.

3. The pneumatic tire as set forth in claim 1 wherein the winding pitch at both axially outer sides is in a range from 60% to 75% or 65% to 70% of the width of the strip.

4. The pneumatic tire as set forth in claim 1 wherein the winding pitch at both axially outer sides being in a range from 100% to 233% of the width of the strip.

5. The pneumatic tire as set forth in claim 1 wherein the width of the central region is 33% to 83% a width of the belt reinforcement structure.

6. The pneumatic tire as set forth in claim 1 wherein spaces from 4 mm to 12 mm are formed in the central region between axially adjacent edges of the strip of the overlay ply.

7. The pneumatic tire as set forth in claim 1 wherein spaces of 27% to 80% of the strip are formed in the central region between the axially adjacent edges of the strip of the overlay ply.

8. The pneumatic tire as set forth in claim 1 wherein the belt reinforcement structure comprises at least one breaker layer, the at least one breaker layer being disposed radially outside the carcass, the at least one breaker layer comprising two plies of cords inclined with respect to the equatorial plane of the pneumatic tire such that cords in one ply cross cords in the other ply.

9. The pneumatic tire as set forth in claim 8 wherein the overlay ply is disposed radially outside of the breaker layer and the strip of parallel cords is wound spirally and circumferentially around the breaker layer from about one axial edge of the breaker layer to about the other axial edge of the breaker layer.

10. The pneumatic tire as set forth in claim 8 wherein the overlay ply is disposed radially outside of the breaker layer and the strip of parallel cords is wound spirally and circumferentially around the breaker layer from overhanging one axial edge of the breaker layer to overhanging the other axial edge of the breaker layer such that each axial edge of overlay ply is aligned proximate to a respective axial edge of the breaker layer.

11. The pneumatic tire as set forth in claim 1 wherein the width of the strip is in a range from 9 mm to 27 mm.

12. The pneumatic tire layer as set forth in claim 1 wherein the winding pitch of the strip changes continuously from in an axially inward direction towards the equatorial plane of the pneumatic tire such that the winding pitch in a central region of the belt reinforcement structure is increased continuously compared to the respective first and second axially outer side to the equatorial plane of the pneumatic tire on each side of the equatorial plane.

13. The pneumatic tire as set forth in claim 12 wherein the winding pitch forms an accordion structure.

14. The pneumatic tire as set forth in claim 1 wherein the winding pitch of the strip changes in steps, from in an axially inward direction towards the equatorial plane of the pneumatic tire such that the winding pitch in a central region of the belt reinforcement structure is increased in steps compared to the respective first and second axially outer side to the equatorial plane of the pneumatic tire on each side of the equatorial plane.

15. The pneumatic tire as set forth in claim 14 wherein the winding pitch forms an accordion structure.

16. The pneumatic tire as set forth in claim 1 wherein the thickness of the strip is in the range from 0.5 mm to 1.1 mm.

17. The pneumatic tire as set forth in claim 1 wherein the winding pitch in the central region at the equatorial plane of the pneumatic tire is about two times the winding pitch at the first and second axially outer side.

18. The pneumatic tire as set forth in claim 1 wherein the spirally and circumferentially wound strip is a continuous spirally and circumferentially wound strip.

19. A pneumatic tire comprising:
a carcass extending between bead portions through sidewall portions and a tread portion, the carcass having at least one ply of parallel cords extending proximate to bead cores of the bead portions; and
a belt reinforcement structure disposed radially outside of the carcass and radially inside of the tread portion, the belt reinforcement structure comprising an overlay ply and at least one breaker layer, the at least one breaker layer being disposed radially outside the carcass and radially inside the overlay ply, the at least one breaker layer comprising two plies of cords inclined with respect to the equatorial plane of the pneumatic tire such that cords in one ply cross cords in the other ply,
the overlay ply comprising a strip of parallel cords wound spirally and circumferentially from a first axially outer side of the overlay ply to a second axially outer side of the overlay ply, the distance between corresponding parts of adjacent strip windings defining a winding pitch,
the winding pitch of the strip changing in an axially inward direction of the pneumatic tire towards the equatorial plane of the pneumatic tire such that the winding pitch in a central region of the belt reinforcement structure is increased compared to the respective first and second axially outer sides of the overlay ply on each side of the equatorial plane;
the winding pitch at both axially outer sides being in a range of from 55% to 85% of a width of the strip,
the width of the central region being in a range of from ⅓ to ⅚ a width of the belt reinforcement structure,
spaces of 4 mm to 12 mm being formed in the central region between the axially adjacent edges of the strip of the overlay ply,
spaces of 27% to 80% of the width of the strip being formed in the central region between the axially adjacent edges of the strip of the overlay ply.

20. A pneumatic tire comprising:
a carcass extending between bead portions through sidewall portions and a tread portion, the carcass having at least one ply of parallel cords extending proximate to bead cores of the bead portions; and
a belt reinforcement structure disposed radially outside of the carcass and radially inside of the tread portion, the belt reinforcement structure comprising an overlay ply and at least one breaker layer, the at least one breaker layer being disposed radially outside the carcass and radially inside the overlay ply, the at least one breaker layer comprising two plies of cords inclined with respect to the equatorial plane of the pneumatic tire such that cords in one ply cross cords in the other ply,
the overlay ply comprising a strip of parallel cords wound spirally and circumferentially from a first axially outer side of the overlay ply to a second axially outer side of the overlay ply, the distance between corresponding parts of adjacent strip defining a winding pitch;
the winding pitch of the strip changing in an axially inward direction of the pneumatic tire towards the equatorial plane of the pneumatic tire such that the winding pitch in a central region of the belt reinforcement structure is increased compared to the respective first and second axially outer sides of the overlay ply on each side of the equatorial plane,
the winding pitch at both axially outer sides being in a range of from 100% to 233% of a width of the strip such that the strip at both axially outer sides does not overlap,
the width of the central region being in a range of from ⅓ to ⅚ a width of the belt reinforcement structure,
spaces of 4 mm to 12 mm being formed in the central region between the axially adjacent edges of the strip of the overlay ply,
spaces of 27% to 80% of the width of the strip being formed in the central region between the axially adjacent edges of the strip of the overlay ply.
